(19) United States
(12) Patent Application Publication
(10) Pub. No.: US 2014/0052833 A1
(43) Pub. Date: Feb. 20, 2014

(54) NETWORK ELEMENT CONFIGURATION MANAGEMENT

(71) Applicants: Kaarle Eerik Ritvanen, Helsinki (FI); Mikko Tapani Saarinen, Helsinki (FI)

(72) Inventors: Kaarle Eerik Ritvanen, Helsinki (FI); Mikko Tapani Saarinen, Helsinki (FI)

(73) Assignee: NOKIA SIEMENS NETWORKS OY, Espoo (FI)

(21) Appl. No.: 14/004,186

(22) PCT Filed: Mar. 11, 2011
(86) PCT No.: PCT/EP2011/053685

§ 371 Date: Oct. 16, 2013

(51) Int. Cl. H04L 12/24

(52) U.S. Cl. CPC H04L 41/0813
USPC 709/221

(57) ABSTRACT

A method and apparatus (102) for network element (101) configuration management is disclosed. The apparatus (102) is configured to perform (301) a configuration object change operation within a single transaction. The apparatus (102) is configured to verify (301) that a target object is a high-level configuration object, and delete (301) the target object, wherein each high-level object removed by a garbage collection algorithm is recorded. The target object is recreated (301), wherein properties of the target object are changed. The high-level objects removed in the deletion step are also re-created (301), wherein, if needed, properties of the high-level objects are adjusted.

### FIELD OF THE INVENTION

The exemplary and non-limiting embodiments of this invention relate generally to configuration management of a network element.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context. Configuration data of a network element (NE) may be modelled as a set of objects arranged into a tree-like hierarchy. An object may represent a physical or logical entity in NE, such as a hardware component, process, service, interface, address, or database. The nature of the represented entity is determined by class, which is a property of the object. Each object contains attribute definitions which characterize the particular entity the object represents. An attribute definition consists of the name of the attribute and the assigned value, specific to the object. The set of the attributes that must or may be used in connection with a specific object is determined by the class of the object. The tree-like hierarchy provides a means to denote simple ownership relations between the objects. More complex relationships may be modelled using reference-type attributes. The properties and mutual relationships of the object classes and attributes are described by NE-specific schema definitions. A configuration management system (CMS) may perform a wide variety of functions, e.g. ensure that the configuration data conforms to the schema, and store the configuration.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented later.

Various aspects of the invention comprise a method, apparatus, and computer-readable storage medium as defined in the independent claims. Further embodiments of the invention are disclosed in the dependent claims.

According to an aspect of the present invention, there is provided a method for performing, in a network apparatus, a network element configuration object change operation within a transaction by verifying that a target object is a high-level configuration object; deleting the target object, wherein each high-level object removed by a garbage collection algorithm is recorded; re-creating the target object, wherein properties of the target object are changed; and re-creating the high-level objects removed in the deletion step, wherein, if needed, properties of the high-level objects are adjusted.

According to another aspect of the present invention, there is provided an apparatus configured to perform a network element configuration object change operation within a transaction by verifying that a target object is a high-level configuration object; deleting the target object, wherein each high-level object removed by a garbage collection algorithm is recorded; re-creating the target object, wherein properties of the target object are changed; and re-creating the high-level objects removed in the deletion step, wherein, if needed, properties of the high-level objects are adjusted. According to another aspect of the present invention, there is provided a computer-readable storage medium embodying a program of instructions executable by a processor to perform actions directed toward performing a network element configuration object change operation within a transaction by verifying that a target object is a high-level configuration object; deleting the target object, wherein each high-level object removed by a garbage collection algorithm is recorded; re-creating the target object, wherein properties of the target object are changed; and re-creating the high-level objects removed in the deletion step, wherein, if needed, properties of the high-level objects are adjusted.

### BRIEF DESCRIPTION OF THE DRAWINGS

In the following the invention will be described in greater detail by means of exemplary embodiments with reference to the accompanying drawings, in which

FIG. 1 shows a simplified block diagram illustrating an exemplary system architecture;

FIG. 2 illustrates apparatuses according to embodiments of the invention;

FIG. 3 is a signalling chart illustrating embodiments of the invention;

FIGS. 4 and 5 are flow charts illustrating embodiments of the invention.

### DETAILED DESCRIPTION OF SOME EMBODIMENTS

A configuration management system (CMS) provides an application programming interface (API) for reading and altering the configuration data at run-time. API may also provide a call-back mechanism allowing network element (NE) software to receive notifications on configuration changes. Moreover, the users of API are authenticated in order to provide access control to the configuration data according to access control lists (ACL). The network element may provide a command line interface and possibly a graphical user interface that allow human operators to view and alter the configuration data. Other interfaces may be provided as well on top of API.

Configuration management refers to a set of functions used to control the configuration of an apparatus or system. It may control the extension or reduction of the apparatus or system, the status of the constituent parts, and the identity of their allocation. A configuration manager (CM) entity allows the system to control operational parameters, including network element parameters and/or network element connection parameters.

Network element configuration management may rely on a data model and structure like the one described above. CMS may be based e.g. on a lightweight directory access protocol (LDAP); hence, the data model is derived from that of LDAP, which conforms to the description given above. Also extensible mark-up language (XML) documents may be seen as instances of this hierarchical data model, where objects are called elements. NETCONF protocol which describes a standard interface to NE configuration systems, uses an XML-based data model. An operation for altering attribute values and reference assignments has been defined in a prior art solution PCT/EP2010/067984, defining a network element configuration management paradigm reducing the implementation effort for configuration models and user interfaces. In the method, an apparatus maintains configuration data on the network element. A set of configuration objects is created in the configuration data, wherein if a predetermined condition is satisfied, yet another configuration object is created in the configuration data. If said yet another configuration object satisfies said predetermined condition or another predetermined condition, one or more further configuration objects are created in the configuration data. Dependency information on the configuration objects satisfying said predetermined condition or said another predetermined condition and on the configuration objects created based on said predetermined condition or said another predetermined condition is stored in the configuration data. The prior art solution utilizes a generalized prototype system with multiple inheritance, allowing the configuration expansion and integrity checking logic to be expressed using special-purpose declarations in object prototype definitions, thus eliminating the need for partially redundant schema-specific program logic. The prior art solution also employs a dependency tracking system in order to automatically provide referential integrity checking, garbage collection, and reduction to a series of procedural operations.

In a configuration management system (CMS) taking advantage of the aforementioned prior art solution, special-purpose declarations control the framework in the process of configuration expansion. Configuration expansion means automatic creation of a detailed configuration object model based on the high-level configuration objects created by the operator of the network element. The configuration expansion algorithm constructs a graph of dependencies between the configuration objects, in order to implement e.g. garbage collection (for a generic object deletion operation) and a generic configuration reduction operation. The latter refers to a process of finding out a series of configuration commands that would produce the current configuration when executed in NE's factory default state.

It has not been described how the network element operator is able to change the name, primary class, or superior of a configuration (instance) object. This may be highly inconvenient, for example, in the following cases. A first case is, if a NE operator has created configuration representing a logical entity within NE. The entity has a name which describes its purpose and is visible in the configuration, but which does not affect the actual operation of the entity. The operator selects the name according to a naming policy but it is unable to easily rename the object when that policy changes. A second case may be, if a configuration database contains an object representing a physical hardware unit. A primary class of the object corresponds to a specific type of the unit. Eventually, the unit type reaches end-of-life, forcing the operator to replace failing units of that type by units of another, backwards compatible type. In that case, the configuration database should be updated respectively, but that becomes an unnecessarily heavy operation unless CMS supports changing the primary type of an object.

It is not straightforward to implement such a change operation when configuration expansion is done as described in the prior art solution, controlled by a set of application-specific declarations. For the sake of consistency, changing the name, primary class and/or superior (hereafter jointly referred to as properties) of a high-level object should result in the same detailed configuration as if the object was originally created with the new properties. As the properties of the object may affect the existence, number, and properties of other configuration objects in nearly arbitrary way (within the constraints of the declaration language), identifying the corresponding changes in the detailed configuration view is not a trivial thing to do.

Conventional CMSs typically provide a function for renaming and possibly relocating configuration objects. Not all CMSs implement a class-based type system, but the ones that do may potentially allow changing the primary class of objects. Supporting changes in the properties of an object cannot be trivially implemented by CMS employing the techniques disclosed in the prior art solution. In the absence of such a change operation, the only way to make such changes is to delete the object in question and re-create it with different parameters. However, as the garbage collection algorithm triggered by the generic deletion operation utilizes the object dependency graph to delete other related objects as well, also those related objects should be re-created, potentially with parameters different from what was originally used. The deletion and re-creation of the objects should be done manually by the NE operator.

An exemplary embodiment involves implementing a change operation for object properties (hereafter merely referred to as a change operation) in a configuration management system (CMS) that utilizes the techniques disclosed in the prior art solution described above. This is accomplished by storing additional information along with the object dependencies, and using this information to automate the manual deletion and re-creation steps of the prior art solution.

In an exemplary embodiment, a basic change operation is described. According to an exemplary embodiment, CMS internally implements the change operation as follows (within a single transaction). A transaction model described in the prior art solution applies here. Hence, the transaction has e.g. atomicity, consistency, and isolation properties, as well as nesting capabilities. Following implementation techniques may be used in the basic change operation according according to an exemplary embodiment. 1) Verify that the target object is a high-level configuration object. 2) Delete the target object, recording all high-level objects removed by the garbage collection algorithm. 3) Re-create the target object, changing its properties. 4) Re-create all high-level objects defeted in “2)”, adjusting their properties when appropriate. If this cannot be done for each of those objects, fail the transaction.

Relevant detail-level objects are automatically (re-)created in “3)” and “4)” as in a conventional object creation scenario. As there may be dependencies between the creation operations, the objects should be re-created in the same order as they were originally created to the database.

The object creation operation accepts the object properties, i.e. superior, name, and primary class, as input. The change operation accepts the same inputs, and in “3)” forwards them to the re-creation sub-operation of the target object (hereafter the main object).

As regards the high-level objects that became victims of garbage collection in “2)”, those input properties for their recreation sub-operations (“4)”) that refer to other objects may need some adjustment from the original values. In practice, such a property may include the path of the superior object, or the object name, which is actually another object's path name in case of a reference assignment.

The reason for the adjustment need includes that properties of any object, including its path name (a concatenation of the superior's path name and the object's own name), are subject to change in a change operation executed for one main object.

In order to do such adjustments automatically, it is necessary to recognize the identities of the relevant objects before and after the main change, i.e. deletion and re-creation of the main object (“2)” and “3)”). Therefore, when the properties of garbage-collected high-level objects are recorded in “2)”, also the identities of the objects referred to by those properties are recorded. When the object is about to be re-created in “4)”, CMS attempts to find objects with similar identities in the database as was recorded with that object. The properties are correspondingly adjusted with the potentially changed path of the object holding the correct identity. If for any recorded identity no object holding that identity is found after the main change, the change operation fails, and the transaction is rolled back. Possible methods for object identification are described below in connection with a basic method for object identification and an advanced method for object identification.

There are also other reasons for which some of the sub-operations may fail. For example, the operator may request a change that somehow violates the schema definitions, or some REQUIRES dependencies may prevent the deletion of some objects in “2)”. Failures of this kind make the whole change transaction fail as well.

In an exemplary embodiment, an advanced change operation is described. Four types of dependencies (directed relationships between two configuration objects, called the subject and the object) may be defined:
DEPENDS_ON: This dependency implies that the subject is defeted when the object is deleted at the latest. Each configuration object holds this kind of dependency at least to its superior object in the hierarchy.
USES: This dependency justifies the existence of the object and prevents its deletion by automatic garbage collection as long as the subject exists.
REQUIRES: This dependency prevents deletion of the object unless the subject is deleted in the same transaction.
EXPORTS: This dependency indicates that the object has been created explicitly by the operator, i.e. is part of the high-level configuration. The subject is the root object. This dependency only exists with a corresponding USES dependency. Normally, a deletion operation fails if there is such a REQUIRES dependency, the object of which is garbage-collected based on its DEPENDS_ON and USES dependencies and the subject is not. Dependencies of this kind fail the simple change algorithm presented above in connection with the basic change operation, since it includes a normal deletion operation as “2)”. However, the algorithm may be enhanced by recording the blocking REQUIRES dependencies in “2)”, including the identities of their objects, but not letting them to immediately fail the transaction. Thus, in an exemplary embodiment, a fifth item is added:

5) Reconstruct the REQUIRES dependencies recorded in “2)”. The path name of the subject remains the same. As regards the object, CMS attempts to find an object with the same identity as was recorded for that dependency and use that. If no such object is found, the change operation fails, and the transaction is rolled back (i.e. reversed, rolled backwards).

In an exemplary embodiment, a basic method for object identification is described. One option for identifying objects before and after the main change may be based on the relative object paths. In this method, the (direct and indirect) post-change subordinates of the main object are identified with those pre-change subordinates of the main object that have identical relative path to the main object. The other objects are identified using their absolute paths.

This basic method for object identification is a straightforward solution that works in simple cases. It is possible that the properties of the main object affect other objects in a non-trivial way via the rules and implied object declarations. The aforementioned solution does not necessarily work if the affected objects are not subordinates of the main object, or the rule or implied object declaration behavior somehow depends on the properties of the main object.

In an exemplary embodiment, an advanced method for object identification is described. The more sophisticated object identification method is based on object dependencies. The four types of dependencies (i.e. DEPENDS_ON, USES, REQUIRES, EXPORTS) defined are listed above in connection with the advanced change operation.

At a high level, dependencies of type DEPENDS_ON, EXPORTS, and USES determine the reason of existence for any particular object for the purposes of configuration reduction and garbage collection. They single out the operator actions and other configuration objects that contribute to the existence of the object.

This leads to an object identification method where the identity of an object is determined by the reason for its existence, i.e. the set of aforementioned dependencies and the identity of the related higher level objects. However, the information conveyed by these dependencies is not as such sufficient for the identification purposes. It is not possible to tell for:
a DEPENDS_ON dependency which rule and selector thereof (if any) triggered the creation of its subject, and
a USES dependency which implied object declaration of which object class definition or rule (if any) triggered the creation of its object.

Ignoring these facts may result in inconsistent behavior of the change operation in case of complex rules and implied object declarations.

An exemplary embodiment describes a dependency-based object identification method which stores additional information with the dependencies in order to make them uniquely determine the objects' reason of existence.

In an exemplary embodiment, each object class definition may be assigned a static class identifier (SCI) when the schema is read by CMS on startup.

Each dependency of type DEPENDS_ON, EXPORTS, and USES may have an associated static dependency identifier (SDI) which is stored along with the dependency information in the configuration database.

When an EXPORTS dependency is created, it is assigned a static dependency identifier (SDI) using a monotonically increasing function. Hence, SDIs of EXPORTS dependencies reflect the creation order of the corresponding high-level objects.

When a USES dependency is created for an object implied directly by a declaration in an object class definition, the dependency's SDI may be calculated from the static class identifier (SCI) of the object class definition containing the implied object declaration, and the sequence number of the implied object declaration within the object class definition.

When a USES dependency is created for an object implied by rule processing, the dependency's SDI may be calculated from the sequence number of the implied object declaration (within the rule) which was responsible for the creation of the dependency. The other USES dependencies are not assigned any SDI.

When a DEPENDS_ON dependency is created in between an object matching a selector of a rule and a match object, the dependency's SDI may be calculated from the static class identifier (SCI) of the object class definition containing the rule, the sequence number of the rule within the object class definition, and the sequence number of the selector owning the match object (within the rule definition). The other DEPENDS_ON dependencies may be assigned a constant SDI.

In an exemplary embodiment, each dependency that has a static dependency identifier (SDI) also has an associated dynamic dependency identifier (DDI). Some configuration objects have an associated dynamic object identifier (DOI).

The dynamic dependency identifier (DDI) of a dependency may be calculated as follows. DDI of a DEPENDS_ON dependency may be calculated from its own SDI and the dynamic object identifier (DOI) of its object. DDI of an EXPORTS dependency may be calculated from its own SDI only. DDI of a USES dependency may be calculated from its own SDI and the dynamic object identifier (DOI) of its subject. The DDI calculation algorithm may be different for each dependency type.

The dynamic object identifier (DOI) of a configuration object may be calculated as follows. If the object is the object of an EXPORTS dependency, the object's DOI is calculated from the dynamic dependency identifier (DDI) of that dependency. If the object is not the object of any EXPORTS dependency but is the object of one or more USES dependencies having a static dependency identifier (SDI), the object's DOI is calculated from the dynamic dependency identifiers (DDI) of those dependencies. If the object is not the object of any EXPORTS or USES dependency, the object's DOI is calculated from the dynamic dependency identifiers (DDI) of the DEPENDS_ON dependencies it holds (i.e. is the subject of).

The DOI calculation algorithm is deterministic for any given set of dependencies. If there are cyclic dependency chains formed by dependencies having SDIs such that the dynamic object identifier (DOI) cannot be computed as described above, the object does not have a dynamic object identifier (DOI). The dynamic object identifier (DOI) of an object and the dynamic dependency identifiers (DDI) of its dependencies are dynamic properties in the sense that they may change due to changes in the database, even though the object itself is not changed. In contrast, the static dependency identifier (SDI) of each dependency remains static over the lifespan of the dependency and is stored in the database.

The calculations of DDIs, DOIs, and derived SDIs may be carried out by utilizing a hash function, making it improbable that two sets of input parameters yield equal identifiers. In an exemplary embodiment, a change operation algorithm is described. The advanced object identification method as described above is based on their DOIs. The dynamic object identifiers (DOI) are constructed such that they uniquely encode the entire information on the objects' reasons of existence. Therefore, it is possible to identify objects before and after the main change based on them, even if their path names have changed in a non-trivial way. When using an advanced DOI-based identification method and an advanced change operation, the generic algorithm (items “1)” to “5)”) may be written as follows. 1) Verify that the main object is a high-level configuration object, i.e. the object of an EXPORTS dependency. 2) Delete the main object, recording all high-level objects removed by the garbage collection algorithm and the dynamic object identifiers (DOI) of the related objects. The dynamic object identifiers (DOI) are computed from the data-base state preceding this step (not from an intermediate state during the garbage collection). Do not let any REQUIRES dependency to fail the transaction at this point but record them and the dynamic object identifiers (DOI) of their objects. 3) Re-create the main object, changing its properties but retaining the original SDI of its EXPORTS dependency. 4) Re-create the high-level objects deleted in “2)”, retaining the original SDIs of their EXPORTS dependencies and in the order indicated by the said identifiers. An object is recreated under the object having the same DOI as the object's superior had in the beginning of the transaction. If the object is a reference assignment, the target object is set to the object having the same DOI as the original target object. If no object holds a particular recorded DOI, the transaction fails. 5) Reconstruct the REQUIRES dependencies recorded in “2)”. The path name of the subject remains the same. The dependency object is the object holding the same identity as the original object. If no object holds that particular DOI, the transaction fails.

It should be noted that finding an object with a particular DOI from the database is not necessarily a heavy operation, even though DOI is a dynamic property. In most cases, the majority of the objects retain their original path names and DOIs in the operation, which may be exploited by the object lookup algorithm.

In an exemplary embodiment a method and apparatus are disclosed for altering object properties in a rule-based configuration management system. By means of an exemplary embodiment, usability of NE configuration tools may be enhanced as a change operation for objects can be provided.

Exemplary embodiments of the present solution will now be described more fully hereinafter with reference to the accompanying drawings, in which some, but not all embodiments of the present solution are shown. Indeed, the present solution may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments of present solution are applicable to any communication device, network element, user equipment, server, corresponding component, and/or to any communication system or any combination of different communication systems providing network element configuration management. The communication system may be a wireless communication system or a communication system utilizing both fixed networks and wireless networks. The protocols used and the specifications of communication systems, devices and network elements, especially in wireless communication, develop rapidly. Such development may require extra changes to an embodiment. Therefore, all words and expressions should be interpreted broadly and are intended to illustrate, not to restrict, the embodiment.

In the following, different embodiments will be described using, as an example of a system architecture to which the embodiments may be applied, an architecture based on the third-generation wireless communication system UMTS (universal mobile telecommunication system) without restricting the embodiment to such an architecture, however.

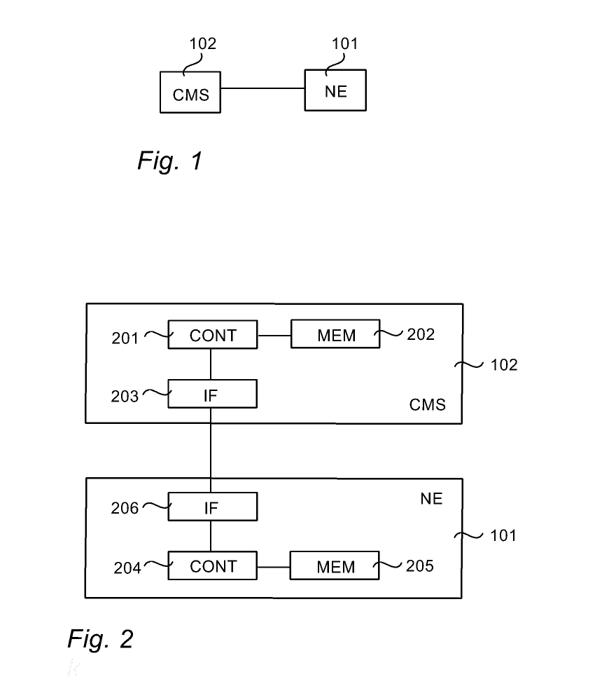

A general architecture of a communication system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different.

It is apparent to a person skilled in the art that the systems also comprise other functions and structures. It should be appreciated that the functions, structures, elements, and protocols used in or for group communication are irrelevant to the actual invention. Therefore, they need not be discussed in more detail here.

FIG. 1 shows a network element 101 such as a base station (BS, Node B), base station controller (BSC), home location register (HLR), mobile switching centre (MSC), a media gateway (MGW), a radio network controller (RNC), a visitor location register (VLR), a transcoding rate adaptation unit (TRAU), a serving GPRS (general packet radio service) support node (SGSN), or a home node B gateway (HNB-GW), mobility management entity and enhanced packet core gateway (MME/EPC-GW), or any other network element of a communications system. The network element is connected to a configuration management device 102. FIG. 1 only illustrates a simplified example.

In practice, the network may include more network element and devices. It should be appreciated that the network element and the configuration management device may also be connectable to each via one or more further devices (not shown in the Figure). It should be appreciated that the configuration management device 102 may also be an integral part of the network element 101. The embodiments are not, however, restricted to the network given above as an example, but a person skilled in the art may apply the solution to other communication networks provided with the necessary properties.

FIG. 2 illustrates examples of apparatuses according to embodiments of the invention. FIG. 2 shows a configuration management device 102 configured to be in a connection with a network element 101. The configuration management device 102 comprises a controller 201 operationally connected to a memory 202 and to an interface 203. The controller 201 controls the operation of the device. The memory 202 is configured to store software and data. The interface 203 is configured to setup and maintain the connection with the network element 101.

The network element 101 comprises a controller 204 operationally connected to a memory 205 and an interface 206. The controller 204 controls the operation of the network element. The memory 205 is configured to store software and data. The interface 206 is configured to setup and maintain the connection with the configuration management device 102.

In an embodiment, the network element is connected to the configuration management device via another device.

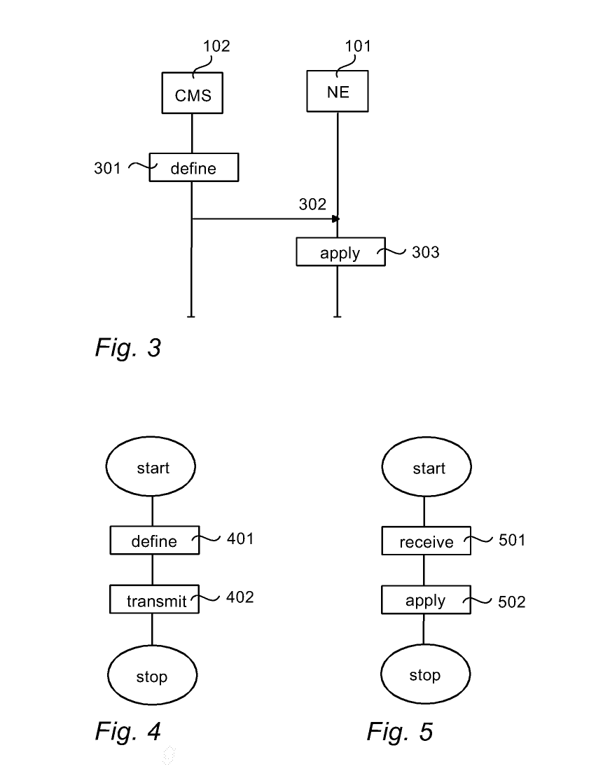

In an embodiment, the configuration management device may define network element configuration parameter and provide the configuration parameter to the network element. The signalling chart of FIG. 3 illustrates the required signalling. In the example of FIG. 3, the configuration management device 102 defines 301 the network element configuration parameter (e.g. a changed configuration object) and transmits 302 the configuration parameter to the network element 101.

The configuration management device 102 and the network element 101 may then apply 303 the parameter. Alternatively, the configuration data may be transmitted to the network element 101 such that the network element 101 initiates a query to which the configuration management device 102 responds.

FIG. 4 is a flow chart illustrating a non-limiting embodiment of the invention. In step 401, the configuration management device defines (as described above) a network element configuration parameter (e.g. a changed configuration object). In step 402, the configuration management device transmits the parameter to the network element. Alternatively, the configuration data may be transmitted to the network element such that the network element initiates a query to which the configuration management device responds.

FIG. 5 is a flow chart illustrating a non-limiting embodiment of the invention from the network element's point of view. In step 501, the network element receives a network element configuration parameter (e.g. a changed configuration object) from the configuration management device. In step 502, the network element applies the configuration parameter.

Alternatively, the configuration data may be transmitted to the network element such that the network element initiates a query to which the configuration management device responds. The steps, signalling messages and related functions described in FIGS. 1 to 5 are in no absolute chronological order, and some of the steps may be performed simultaneously or in an order differing from the given one. Other functions can also be executed between the steps or within the steps and other signalling messages sent between the illustrated messages. Some of the steps can also be left out or replaced with a corresponding step. The signalling messages are only exemplary and may even comprise several separate messages for transmitting the same information. In addition, the messages may also contain other information.

An apparatus able to perform the above-described steps may be implemented as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, are configured to perform network element configuration management as described above.

The computer program may be in source code form, object code form, or in some intermediate form, and it may be stored in some sort of carrier, which may be any entity or device capable of carrying the program. Such carriers include a record medium, computer memory, read-only memory, an electrical carrier signal, a telecommunications signal, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible.

When selecting the method of implementation, a person skilled in the art will consider the requirements set for the size and power consumption of the apparatus 102, the necessary processing capacity, production costs, and production volumes, for example.

Thus, according to an exemplary embodiment, there is provided a method comprising performing, in a network apparatus, a configuration object change operation within a transaction by verifying that a target object is a high-level configuration object; deleting the target object, wherein each high-level object removed by a garbage collection algorithm is recorded; re-creating the target object, wherein properties of the target object are changed; and re-creating the high-level objects removed in the deletion step, wherein, if needed, properties of the high-level objects are adjusted.

According to another exemplary embodiment, there is provided an apparatus configured to perform a network element configuration object change operation within a transaction by verifying that a target object is a high-level configuration object; deleting the target object, wherein each high-level object removed by a garbage collection algorithm is recorded; re-creating the target object, wherein properties of the target object are changed; and re-creating the high-level objects removed in the deletion step, wherein, if needed, properties of the high-level objects are adjusted.

According to yet another exemplary embodiment, there is provided an apparatus that is configured to fail the transaction if the re-creating of the high-level objects cannot be carried out for each high-level object removed in the deletion step.

According to yet another exemplary embodiment, the transaction further comprises reconstructing REQUIRES dependencies recorded in the deletion step, wherein a path name of a subject remains the same, the method comprising attempting to find an object with a same identity as was recorded for respective dependency and use said object, wherein if no such object is found, the change operation is failed, and the transaction is rolled back.

According to yet another exemplary embodiment, there is provided an apparatus that is configured to implement the configuration object change operation within a single transaction.

According to yet another exemplary embodiment, there is provided an apparatus that is configured to re-create the objects in the same order as they were originally created to a configuration database, such that relevant detail-level objects are automatically re-created.

According to yet another exemplary embodiment, an object creation operation accepts the object properties including a superior, name, and/or primary class, as an input; and the object change operation accepts the same input and forwards it to a re-creation sub-operation of the target object.

According to yet another exemplary embodiment, there is provided an apparatus that is configured to recognize the identities of the relevant objects before and after a deletion and/or re-creation of a main object, in order to facilitate automatic adjustment of object properties.

According to yet another exemplary embodiment, there is provided an apparatus that is configured to identify a configuration object based on a relative object path, wherein direct and/or indirect post-change subordinates of a main object are identified using those pre-change subordinates of the main object that have an identical relative object path with respect to the main object.

According to yet another exemplary embodiment, there is provided an apparatus that is configured to identify the other objects using their absolute object paths.

According to yet another exemplary embodiment, there is provided an apparatus that is, at a high level, configured to determine the reason for the existence of a particular object for the purposes of configuration reduction and garbage collection by a DEPENDS_ON dependency, an EXPORTS dependency, and/or a USES dependency.

According to yet another exemplary embodiment, there is provided an apparatus that is configured to assign each object class definition a static class identifier when the schema is read by the apparatus on startup.

According to yet another exemplary embodiment, a dependency of type DEPENDS_ON, EXPORTS, and/or USES has an associated static dependency identifier, wherein the apparatus is configured to store said static dependency identifier, along with the dependency information, in a configuration database. According to yet another exemplary embodiment, there is provided an apparatus that is configured to when an EXPORTS dependency is created, assign the EXPORTS dependency a static dependency identifier using a monotonically increasing function, wherein the static dependency identifiers of the EXPORTS dependencies reflect the creation order of the corresponding high-level objects; when a USES dependency is created for an object implied directly by a declaration in an object class definition, the apparatus is configured to calculate the static dependency identifier of the USES dependency from the static class identifier of the object class definition containing the implied object declaration, and from the sequence number of the implied object declaration within the object class definition; when a USES dependency is created for an object implied by rule processing, the apparatus is configured to calculate the static dependency identifier of the USES dependency from the sequence number of the implied object declaration which was responsible for the creation of the dependency; when a DEPENDS_ON dependency is created in between an object matching a selector of a rule and a match object, the apparatus is configured to calculate the static dependency identifier of the DEPEND_ON dependency from the static class identifier of the object class definition containing the rule, from the sequence number of the rule within the object class definition, and from the sequence number of the selector owning the match object within the rule definition.

According to yet another exemplary embodiment, there is provided an apparatus that is configured to assign the other DEPENDS_ON dependencies a constant static dependency identifier.

According to yet another exemplary embodiment, a dependency that has a static dependency identifier also has an associated dynamic dependency identifier, wherein the apparatus is configured to calculate the dynamic dependency identifier of a DEPENDS_ON dependency from its own static dependency identifier and a dynamic object identifier of its configuration object; calculate the dynamic dependency identifier of an EXPORTS dependency from its own static dependency identifier only; and calculate the dynamic dependency identifier of a USES dependency from its own static dependency identifier, and from the dynamic object identifier of its subject.

According to yet another exemplary embodiment, there is provided an apparatus that is configured to, if the configuration object is an object of an EXPORTS dependency, calculate a dynamic object identifier of the configuration object from the dynamic dependency identifier of the EXPORTS dependency; if the configuration object is not the object of any EXPORTS dependency but is the object of one or more USES dependencies having a static dependency identifier, calculate the dynamic object identifier of the configuration object from the dynamic dependency identifiers of these USES dependencies; and, if the configuration object is not the object of any EXPORTS or USES dependency, calculate the dynamic object identifier of the configuration object from the dynamic dependency identifiers of the DEPENDS_ON dependencies it is the subject of. According to yet another exemplary embodiment, the transaction comprises identifying a configuration object based on the dynamic object identifier of the configuration object.

According to yet another exemplary embodiment, the identifying the configuration object comprises verifying that the main object is a high-level configuration object of an EXPORTS dependency; deleting the main object, wherein the high-level objects removed by the garbage collection algorithm and the dynamic object identifiers of the related objects are recorded, wherein the dynamic object identifiers are computed from the database state preceding the main object deleting step, wherein the REQUIRES dependencies and the dynamic object identifiers of their objects are recorded; recreating the main object, wherein the properties of the main object are changed, and the original static dependency identifier of the EXPORTS dependency of the main object is retained; re-creating the high-level objects deleted in the main object deleting step, wherein the original static dependency identifiers of their EXPORTS dependencies are retained and in the order indicated by said static dependency identifiers, wherein an object is re-created under the object having the same dynamic object identifier as the object's superior had in the beginning of the transaction, wherein if the object was a reference assignment, the target object is set to the object having the same dynamic object identifier as the original target object, wherein if no object holds a particular recorded dynamic object identifier, the transaction fails; reconstructing the REQUIRES dependencies recorded in the main object deleting step, wherein the path name of the subject remains the same, wherein the dependency object is the object holding the same identity as the original object, wherein if no object holds the particular dynamic object identifier, the transaction fails.

According to yet another exemplary embodiment, there is provided a computer-readable storage medium embodying a program of instructions executable by a processor to perform actions directed toward performing a network element configuration object change operation within a transaction by verifying that a target object is a high-level configuration object; deleting the target object, wherein each high-level object removed by a garbage collection algorithm is recorded; recreating the target object, wherein properties of the target object are changed; and re-creating the high-level objects removed in the deletion step, wherein, if needed, properties of the high-level objects are adjusted.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

CMS configuration management system

DDI dynamic dependency identifier

DOI dynamic object identifier

GPRS general packet radio service

GSN GPRS support node

MME mobility management entity

NE network element

SGSN serving GSN

SCI static class identifier

SDI static dependency identifier

ACL access control list

API application programming interface

LDAP lightweight directory access protocol

XML extensible mark-up language

1. A method for configuration management of a network element, the method comprising performing, in a network apparatus, a configuration object change operation within a transaction by
verifying that a target object is a high-level configuration object;
deleting the target object, wherein each high-level object removed by a garbage collection algorithm is recorded;
re-creating the target object, wherein properties of the target object are changed; and
re-creating the high-level objects removed in the deletion step, wherein, if needed, properties of the high-level objects are adjusted.

2. A method of claim 1, wherein the transaction further comprises reconstructing REQUIRES dependencies recorded in the deletion step, wherein a path name of a subject remains the same, the method comprising attempting to find an object with a same identity as was recorded for respective dependency and use said object, wherein if no such object is found, the change operation is failed, and the transaction is rolled back.

3. A method of claim 1, wherein it comprises identifying a configuration object based on a relative object path, wherein direct and/or indirect post-change subordinates of a main object are identified using those pre-change subordinates of the main object that have an identical relative object path with respect to the main object.

4. A method of claim 1, wherein the transaction comprises identifying a configuration object based on the dynamic object identifier of the configuration object.

5. An apparatus configured to perform a network element configuration object change operation within a transaction by
verifying that a target object is a high-level configuration object;
deleting the target object, wherein each high-level object removed by a garbage collection algorithm is recorded;
re-creating the target object, wherein properties of the target object are changed; and
re-creating the high-level objects removed in the deletion step, wherein, if needed, properties of the high-level objects are adjusted.

6. An apparatus of claim 5, wherein the transaction further comprises reconstructing REQUIRES dependencies recorded in the deletion step, wherein a path name of a subject remains the same, the method comprising attempting to find an object with a same identity as was recorded for respective dependency and use said object, wherein if no such object is found, the change operation is failed, and the transaction is rolled back.

7. An apparatus of claim 5, wherein the apparatus is configured to re-create the objects in the same order as they were originally created to a configuration database, such that relevant detail-level objects are automatically re-created.

8. An apparatus of claim 5, wherein
an object creation operation accepts the object properties including a superior, name, and/or primary class, as an input; and
the object change operation accepts the same input and forwards it to a re-creation sub-operation of the target object.

9. An apparatus of claim 5, wherein the apparatus is configured to recognize the identities of the relevant objects before and after a deletion and/or re-creation of a main object, in order to facilitate automatic adjustment of object properties.

10. An apparatus of claim 5, wherein the apparatus is configured to identify a configuration object based on a relative object path, wherein direct and/or indirect post-change subordinates of a main object are identified using those pre-change subordinates of the main object that have an identical relative object path with respect to the main object.

11. An apparatus of claim 10, wherein the apparatus is configured to identify the other objects using their absolute object paths.

12. An apparatus of claim 5, wherein at a high level, the apparatus is configured to determine the reason for the existence of a particular object for the purposes of configuration reduction and garbage collection by a DEPENDS_ON dependency, an EXPORTS dependency, and/or a USES dependency.

13. An apparatus of claim 5, wherein the apparatus is configured to assign each object class definition a static class identifier when the schema is read by the apparatus on startup.

14. An apparatus of claim 5, wherein a dependency of type DEPENDS_ON, EXPORTS, and/or USES has an associated static dependency identifier, wherein the apparatus is configured to store said static dependency identifier, along with the dependency information, in a configuration database.

15. An apparatus of claim 5, wherein the apparatus is configured to
when an EXPORTS dependency is created, assign the EXPORTS dependency a static dependency identifier using a monotonically increasing function, wherein the static dependency identifiers of the EXPORTS dependencies reflect the creation order of the corresponding high-level objects;
when a USES dependency is created for an object implied directly by a declaration in an object class definition, the apparatus is configured to calculate the static dependency identifier of the USES dependency from the static class identifier of the object class definition containing the implied object declaration, and from the sequence number of the implied object declaration within the object class definition;
when a USES dependency is created for an object implied by rule processing, the apparatus is configured to calculate the static dependency identifier of the USES dependency from the sequence number of the implied object declaration which was responsible for the creation of the dependency;
when a DEPENDS_ON dependency is created in between an object matching a selector of a rule and a match object, the apparatus is configured to calculate the static dependency identifier of the DEPEND_ON dependency from the static class identifier of the object class definition containing the rule, from the sequence number of the rule within the object class definition, and from the sequence number of the selector owning the match object within the rule definition.

16. An apparatus of claim 15, wherein the apparatus is configured to assign the other DEPENDS_ON dependencies a constant static dependency identifier.

17. An apparatus of claim 5, wherein a dependency that has a static dependency identifier also has an associated dynamic dependency identifier, wherein the apparatus is configured to
calculate the dynamic dependency identifier of a DEPENDS_ON dependency from its own static dependency identifier and a dynamic object identifier of its configuration object;
calculate the dynamic dependency identifier of an EXPORTS dependency from its own static dependency identifier only; and
calculate the dynamic dependency identifier of a USES dependency from its own static dependency identifier, and from the dynamic object identifier of its subject.

18. An apparatus of claim 5, wherein the apparatus is configured to
if the configuration object is an object of an EXPORTS dependency, calculate a dynamic object identifier of the configuration object from the dynamic dependency identifier of the EXPORTS dependency;
if the configuration object is not the object of any EXPORTS dependency but is the object of one or more USES dependencies having a static dependency identifier, calculate the dynamic object identifier of the configuration object from the dynamic dependency identifiers of these USES dependencies; and
if the configuration object is not the object of any EXPORTS or USES dependency, calculate the dynamic object identifier of the configuration object from the dynamic dependency identifiers of the DEPENDS_ON dependencies it is the subject of.

19. An apparatus of claim 5, wherein the transaction comprises identifying a configuration object based on the dynamic object identifier of the configuration object.

20. An apparatus of claim 19, wherein the identifying the configuration object comprises
verifying that the main object is a high-level configuration object of an EXPORTS dependency;
deleting the main object, wherein the high-level objects removed by the garbage collection algorithm and the dynamic object identifiers of the related objects are recorded, wherein the dynamic object identifiers are computed from the database state preceding the main object deleting step, wherein the REQUIRES dependencies and the dynamic object identifiers of their objects are recorded;
re-creating the main object, wherein the properties of the main object are changed, and the original static dependency identifier of the EXPORTS dependency of the main object is retained;
re-creating the high-level objects deleted in the main object deleting step, wherein the original static dependency identifiers of their EXPORTS dependencies are retained and in the order indicated by said static dependency identifiers, wherein an object is recreated under the object having the same dynamic object identifier as the object's superior had in the beginning of the transaction, wherein if the object was a reference assignment, the target object is set to the object having the same dynamic object identifier as the original target object, wherein if no object holds a particular recorded dynamic object identifier, the transaction fails;
reconstructing the REQUIRES dependencies recorded in the main object deleting step, wherein the path name of the subject remains the same, wherein the dependency object is the object holding the same identity as the original object, wherein if no object holds the particular dynamic object identifier, the transaction fails.

21. A computer-readable storage medium embodying a program of instructions executable by a processor to perform actions directed toward performing a network element configuration object change operation within a transaction by
verifying that a target object is a high-level configuration object;
deleting the target object, wherein each high-level object removed by a garbage collection algorithm is recorded;
re-creating the target object, wherein properties of the target object are changed; and
re-creating the high-level objects removed in the deletion step, wherein, if needed, properties of the high-level objects are adjusted.
